(19) United States
(12) Patent Application Publication
(10) Pub. No.: US 2026/0266181 A1
(43) Pub. Date: Sep. 10, 2026

(54) Hydraulic Transformer

(71) Applicant: Innas B.V., Breda (NL)

(72) Inventor: Peter Augustinus Johannes Achten, Eindhoven (NL)

(21) Appl. No.: 19/160,983

(22) PCT Filed: Feb. 28, 2024
(86) PCT No.: PCT/EP2024/055045

§ 371 Date: Aug. 29, 2025

(30) Foreign Application Priority Data
Mar. 3, 2023 (EP) 23159986.1

(51) Int. Cl. F01B 3/00

(52) U.S. Cl. CPC F01B 3/0038; F01B 3/0041; F01B 3/0055

(57) ABSTRACT

A hydraulic transformer includes a housing including high-pressure, low-pressure, and operating pressure connections, and a barrel member with compression chambers. A back side of the barrel member includes barrel ports. A face plate is supported by the housing and provided with a front side that supports the back side of the barrel member, a back side that faces the housing, a circumferential outer wall, and a central hole surrounded by a circumferential inner wall. The face plate is rotatable. The front side is provided with three arcuate face plate ports that communicate with the high-pressure connection through a first passage, the low-pressure connection through a second passage and the operating pressure connection through a third passage. One of the passages has an opening at the back side has an opening at the circumferential outer wall, and one has an opening at the circumferential inner wall.

### CROSS-REFERENCE TO RELATED APPLICATIONS

This application is the United States national phase of International Patent Application No. PCT/EP2024/055045 filed Feb. 28, 2024, and claims priority to European Patent Application No. 23159986.1 filed Mar. 3, 2023, the disclosures of each of which are hereby incorporated by reference in their entireties.

### BACKGROUND

### Technical Field

The present disclosure relates to a hydraulic transformer.

### Technical Considerations

Although certain hydraulic transformers are advantageous in terms of friction, they have a relatively narrow operating range. The high-pressure connection and the low-pressure connection can be fluidly connected to a high-pressure line and a low-pressure line of a common pressure rail system, whereas the operating pressure connection can be fluidly connected to a load, such as a hydraulic cylinder or motor. A general advantage of a hydraulic transformer is that unlike throttling it operates in a non-dissipative manner. Energy can be recuperated and delivered to other loads or stored in hydropneumatic accumulators, for example.

### SUMMARY

An object of the present disclosure is to provide an improved hydraulic transformer. For example, a hydraulic transformer may include a housing including a high-pressure connection, a low-pressure connection and an operating pressure connection, a barrel member which is rotatably mounted in the housing and provided with a plurality of compression chambers of which the volume changes upon rotating the barrel member, wherein a back side of the barrel member includes barrel ports which communicate with the respective compression chambers and a face plate which is supported by the housing and provided with a front side that supports the back side of the barrel member, a back side that faces the housing, a circumferential outer wall and a central hole that is surrounded by a circumferential inner wall, which face plate is rotatable with respect to the housing within a predetermined angle, wherein the front side is provided with three arcuate face plate ports along which the barrel ports travel upon rotating the barrel member, wherein the face plate ports communicate with the high-pressure connection through a first passage in the face plate, the low-pressure connection through a second passage in the face plate and the operating pressure connection through a third passage in the face plate, respectively.

The aforementioned object may be accomplished with a hydraulic transformer according to the present disclosure which is characterized in that one of the first to third passages has an opening at the back side of the face plate, one of the first to third passages has an opening at the circumferential outer wall of the face plate and one of the first to third passages has an opening at the circumferential inner wall of the face plate.

An advantage of the hydraulic transformer according to the present disclosure is that the first to third passages have respective openings at different sides of the face plate, which provides the opportunity to rotate the face plate with respect to the housing through a relatively large angle without the risk of short circuiting between the respective openings. This means that the hydraulic transformer has a wide operating range.

In some embodiments the hydraulic transformer comprises a main shaft through which the barrel member is rotatable with respect to the housing, which main shaft is mounted in the housing and rotatable about a first axis of rotation, wherein the main shaft has a flange extending perpendicularly to the first axis of rotation, a plurality of pistons including respective spherical piston heads, which pistons are fixed to the flange at equiangular distance about the first axis of rotation and which have centrelines parallel to the first axis of rotation, wherein the barrel member comprises a plurality of separate sleeves within which the respective pistons are movable, thus forming the compression chambers, wherein a bearing surface of the barrel member opposite to its back side supports sleeve bottoms of the sleeves, wherein the barrel member including the sleeves are rotatable about a second axis of rotation which intersects the first axis of rotation by an acute angle such that upon rotating the main shaft and the barrel member including the sleeves each of the pistons moves with respect to the cooperating sleeve between a bottom dead centre and a top dead centre, wherein the barrel ports communicate with the respective compression chambers through barrel member passages in the barrel member and through-holes in the sleeve bottoms. In some embodiments the hydraulic transformer operates according to the so-called floating cup principle which has minimum friction.

The central hole in the face plate may be a through-hole, which allows the central hole to be fluidly connected to adjacent channels through openings at both the front side and the back side of the face plate.

In some embodiments the first passage has an opening at the back side of the face plate, the second passage has an opening at the circumferential outer wall of the face plate and the third passage has an opening at the circumferential inner wall of the face plate. This means that the opening at the back side of the face plate is fluidly connected with the high-pressure connection, the opening at the circumferential outer wall of the face plate is fluidly connected with the low-pressure connection and the opening at the circumferential inner wall of the face plate is fluidly connected with the operating pressure connection.

In some embodiments, the opening at the back side of the face plate is aligned with the cooperating face plate port and, for example, may have substantially the same shape and dimensions as the cooperating face plate port, since this minimizes a difference of pressure fields at opposite sides of the face plate, which in turn minimizes friction between the face plate and one of the barrel member and the housing. As a consequence, rotation of the face plate with respect to the housing requires relatively low power.

In some embodiments, the one of the first to third passages which has an opening at the circumferential outer wall of the face plate also has an opening at the back side of the face plate which is aligned with the cooperating face plate port and closed by an inner wall of the housing and which, for example, may have substantially the same shape and dimensions as the cooperating face plate port. This minimizes a difference of pressure fields at opposite sides of the face plate at the corresponding face plate port at the front side and the opening at the back side of the face plate. It is noted that under operating conditions hydraulic fluid does not flow, or only a very small leakage, through the opening at the back side of the face plate.

In some embodiments, the one of the first to third passages which has an opening at the inner wall of the face plate also has an opening at the back side of the face plate which is aligned with the cooperating face plate port and closed by an inner wall of the housing and which, for example, may have substantially the same shape and dimensions as the cooperating face plate port. This minimizes a difference of pressure fields at opposite sides of the face plate at the corresponding face plate port at the front side and the opening at the back side of the face plate. It is noted that under operating conditions hydraulic fluid does not flow, or only a very small leakage, through the opening at the back side of the face plate.

The main shaft may be a hollow main shaft of which an internal space communicates via a central hole in the barrel member with the central hole of the face plate. In some embodiments, one of the central hole of the barrel member and the main shaft is provided with an inner sleeve including a spherical outer surface portion and the other one of the central hole of the barrel member and the main shaft is provided with an outer sleeve including a circular cylindrical inner surface which fits around the spherical outer surface portion of the inner sleeve. This allows the central hole to be fluidly connected to a channel at a distance from the face plate in a direction which is directed away from its front side. The cooperating inner and outer sleeves may create a sealed connection between the central hole in the barrel member and the internal space of the main shaft.

In some embodiments the arc length of the face plate port which communicates with the high-pressure connection is larger than the arc length of the face plate port which communicates with the low-pressure connection and larger than the arc length of the face plate port which communicates with the operating pressure connection. This provides the opportunity to create a wide operating range.

The arc length of the face plate port which communicates with the operating pressure connection may be smaller than the arc length of the face plate port which communicates with the low-pressure connection.

In some embodiments, in rotational direction about the second axis of rotation the face plate ports are separated by respective sealing lands, wherein at least one of the sealing lands is provided with a through-hole between the front side and the back side of the face plate which has a flow-through area that is smaller than 5% of the flow-through area of the first passage and which widens in a direction from the front side to the back side of the face plate, wherein said one of the sealing lands, for example, may have a plurality of through-holes in circumferential direction of the face plate. Under operating conditions, the relatively small and widening through-hole generates a force on the face plate which counteracts a pressure field on the corresponding sealing land on the front side of the face plate. This leads to minimized friction between the face plate and the housing, hence facilitating rotation of the face plate. The flow-through area of the through-hole at the front side of the face plate may be smaller than the flow-through area of each of the barrel ports that passes the through-hole.

The flow-through area at the back side of the face plate may be formed by a pocket. It is noted that although using the term flow-through area, under operating conditions hydraulic fluid does not flow, or only a very small leakage, through the flow-through area at the back side of the face plate.

In some embodiments, the flange including the pistons is a first flange including first pistons and the main shaft is provided with a second flange extending perpendicularly to the first axis of rotation, wherein the hydraulic transformer is provided with a plurality of second pistons including respective spherical piston heads, which second pistons are fixed to the second flange at equiangular distance about the first axis of rotation and which have centrelines parallel to the first axis of rotation, wherein the barrel member including the sleeves is a first barrel member including first sleeves and the compression chambers are first compression chambers, wherein the hydraulic transformer is provided with a plurality of separate second sleeves within which the respective second pistons are movable, wherein the hydraulic transformer comprises a second barrel member which is rotatable with respect to the housing and comprises a plurality of separate second sleeves within which the respective second pistons are movable, thus forming respective second compression chambers, wherein a bearing surface of the second barrel member opposite to a back side thereof supports sleeve bottoms of the second sleeves, wherein the second barrel member including the second sleeves are rotatable about a third axis of rotation which intersects the first axis of rotation by an acute angle such that upon rotating the main shaft and the second barrel member including the second sleeves each of the second pistons moves with respect to the cooperating second sleeve between a bottom dead centre and a top dead centre, wherein the back side of the second barrel member includes second barrel ports which communicate through barrel member passages in the second barrel member and through-holes in the sleeve bottoms of the second sleeves with the respective second compression chambers, wherein the face plate is a first face plate and the hydraulic transformer is provided with a second face plate which is supported by the housing and provided with a front side that supports the back side of the second barrel member, a back side that faces the housing, a circumferential outer wall and a central hole that is surrounded by a circumferential inner wall, which second face plate is rotatable with respect to the housing about the third axis of rotation within a predetermined angle, wherein the face plate ports are first face plate ports and the front side of the second face plate is provided with three arcuate second face plate ports along which the second barrel ports travel upon rotating the main shaft and the second barrel member including the second sleeves, wherein the second face plate ports communicate with the high-pressure connection through a first passage in the second face plate, the low-pressure connection through a second passage in the second face plate and the operating pressure connection through a third passage in the second face plate, respectively, wherein one of the first to third passages in the second face plate has an opening at the back side of the second face plate, one of the first to third passages in the second face plate has an opening at the circumferential outer wall of the second face plate and one of the first to third passages in the second face plate has an opening at the circumferential inner wall of the second face plate. When the first pistons and the second pistons are projecting from the first and second flanges, respectively, in opposite directions, the forces on the first and second pistons counteract through the main shaft.

In case of a hollow main shaft, its internal space may communicate with the central hole of the second face plate, which means that it communicates with the central holes of both the first and second face plates.

The first and second face plates may be mechanically coupled to each other through an auxiliary shaft which extends through the internal space of the main shaft, which allows the first and second face plates to be rotated synchronously. The auxiliary shaft may also be a hollow shaft such that hydraulic fluid can also flow through the auxiliary shaft.

In the event that the main shaft is provided with the first and the second flange, the main shaft may be rotatably mounted in the housing through a bearing between the first and second flanges.

These and other features and characteristics of the present disclosure, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosed subject matter.

### BRIEF DESCRIPTION OF THE DRAWINGS

The present disclosure will hereafter be elucidated with reference to schematic drawings showing embodiments of the present disclosure by way of example.

FIG. 1 is a perspective view of a hydraulic transformer according to some embodiments of the present disclosure.

FIG. 2 is a similar view as FIG. 1, showing the hydraulic transformer from a different side.

FIG. 3 is an enlarged cutaway view of the hydraulic transformer as shown in FIG. 1.

FIG. 4 is an enlarged sectional view of the hydraulic transformer as shown in FIG. 1.

FIG. 5 is a similar view as FIG. 4, showing a part thereof on a larger scale.

FIG. 6 is a perspective sectional view from opposite sides of a first barrel member of the hydraulic transformer as shown in FIG. 1.

FIG. 7 is a frontal view of a front side of a second face plate of the hydraulic transformer as shown in FIG. 1.

FIG. 8 is a perspective view of the second face plate as shown in FIG. 7, showing its back side.

FIG. 9 is a perspective view of a portion of a housing of the hydraulic transformer as shown in FIG. 1, illustrating two different operating conditions.

FIG. 10 is an illustrative view of flow of hydraulic fluid through a high-pressure channel of the hydraulic transformer as shown in FIG. 1.

FIG. 11 is a similar view as FIG. 10, illustrating flow of hydraulic fluid through a low-pressure channel of the hydraulic transformer as shown in FIG. 1.

FIG. 12 is a similar view as FIG. 10, illustrating flow of hydraulic fluid through an operating pressure channel of the hydraulic transformer as shown in FIG. 1.

FIG. 13 is an illustrative view of a hydraulic circuit in and around the hydraulic transformer of FIG. 1.

### DETAILED DESCRIPTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the embodiments as they are oriented in the drawing figures. However, it is to be understood that the present disclosure may assume various alternative variations and step sequences, except where expressly specified to the contrary. It is also to be understood that the specific devices and processes illustrated in the attached drawings, and described in the following specification, are simply exemplary and non-limiting embodiments or aspects of the disclosed subject matter. Hence, specific dimensions and other physical characteristics related to the embodiments or aspects disclosed herein are not to be considered as limiting.

No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” Also, as used herein, the terms “has,” “have,” “having,” or the like are intended to be open-ended terms.

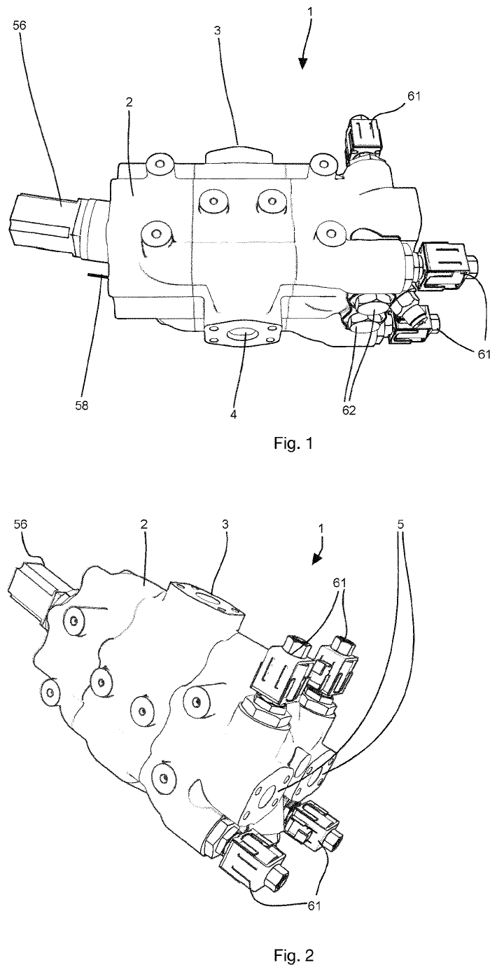

FIGS. 1 and 2 show an outer side of a hydraulic transformer 1 according to some embodiments of the present disclosure. The hydraulic transformer 1 has a housing 2, which is provided with a high-pressure connection 3, a low-pressure connection 4 and two operating pressure connections 5. The housing 2 forms an assembly of separate elements in order to fit parts inside the housing 2. The hydraulic transformer 1 may be part of a hydraulic circuit including a high-pressure line which communicates with the high-pressure connection 3 and a low-pressure line which communicates with the low-pressure connection 4. The operating pressure connections 5 may communicate with a hydraulic cylinder or a hydraulic motor which can be operated by the hydraulic transformer 1 through adjusting hydraulic pressure at the operating pressure connections 5. The flow direction of hydraulic fluid from and to the operating pressure connections 5 is controlled by valves which will be described later with reference to FIG. 13.

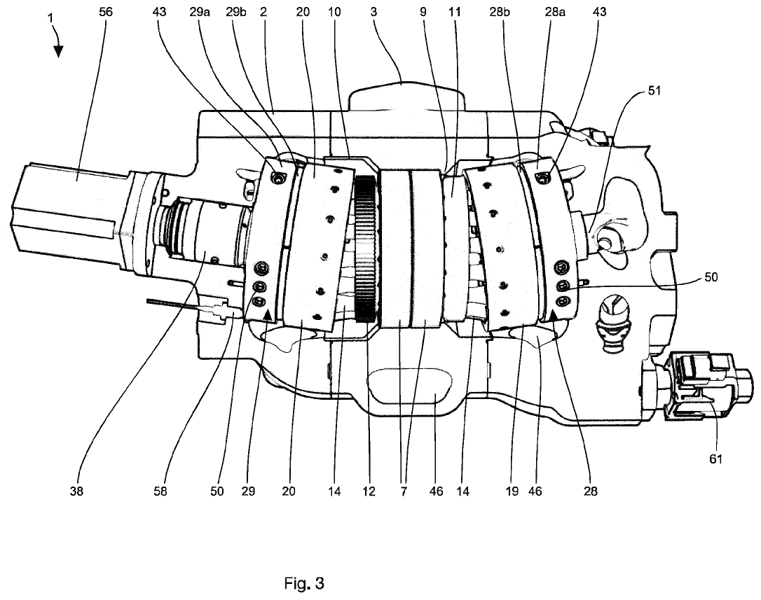

FIGS. 3-5 show an interior side of the hydraulic transformer 1. The hydraulic transformer 1 has a hollow main shaft 6 which is supported by the housing 2 through a pair of angular contact roller bearings 7. The main shaft 6 is rotatable with respect to the housing 2 about a first axis of rotation 8. The bearings 7 are located at a central portion of the housing 2 as seen in longitudinal direction of the first axis of rotation 8. The bearings 7 have fixed positions with respect to the housing 2 in longitudinal direction of the first axis of rotation 8 by means of a collar 9 of the housing 2 and a sleeve 10 between which circumferential outer edges of the bearings 7 are sandwiched.

The main shaft 6 is provided with a first flange 11 and a second flange 12, which extend perpendicularly to the first axis of rotation 8 at either side of the bearings 7. Circumferential inner edges of the bearings 7 are sandwiched between the first and second flanges 11, 12. The second flange 12 is mounted as a separate element onto the main shaft 6 after placing the bearings 7 next to the first flange 11. A key 13 locks the second flange 12 with respect to the main shaft 6 in rotational direction about the first axis of rotation 8. The second flange 12 has a toothed circumference which is used for rotational speed detection, see FIG. 3.

At each of the first and second flanges 11, 12 a plurality of pistons 14 are fixed at equiangular distance about the first axis of rotation 8, in this case fifteen pistons 14. The pistons 14 project from the respective first and second flanges 11, 12 away from each other. The pistons 14 have centre lines which extend parallel to the first axis of rotation 8. In this case they are fixed to the respective first and second flanges 11, 12 by screws, but alternative fixing means are conceivable.

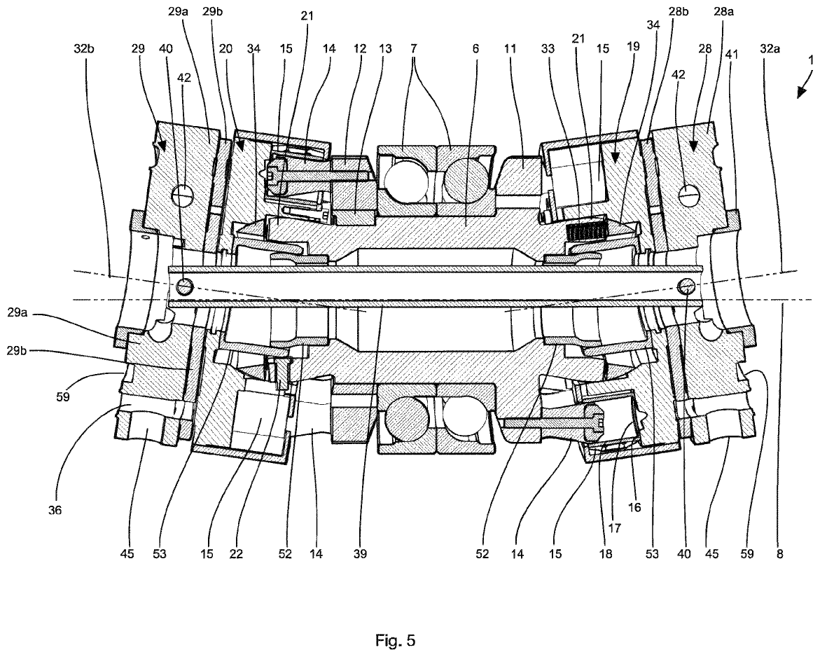

Each of the pistons 14 cooperates with a separate sleeve 15 to form a compression chamber of variable volume. In this case the hydraulic transformer 1 has 30 compression chambers. Each of the sleeves 15 comprises a sleeve bottom 16 including a central through-hole 17 and a circular-cylindrical sleeve jacket 18, see FIG. 5. The sleeve jacket 18 extends from the sleeve bottom 16. Each piston 14 is sealed directly to the inner wall of the cooperating sleeve jacket 18 through a piston head of the piston 14 which has a spherical outer side.

The sleeve bottoms 16 are supported by a bearing surface of a first barrel member 19 and a bearing surface of a second barrel member 20. The sleeves 15 are slidable on the bearing surfaces of the first and second barrel members 19, 20, which may be referred to as the floating cup principle. The first and second barrel members 19, 20 are fitted around the main shaft 6 by means of respective ball hinges 21 and are coupled to the main shaft 6 by means of keys 22, see FIG. 5. Consequently, the first and second barrel members 19, 20 rotate together with the main shaft 6 under operating conditions. The first and second barrel members 19, 20 are the same.

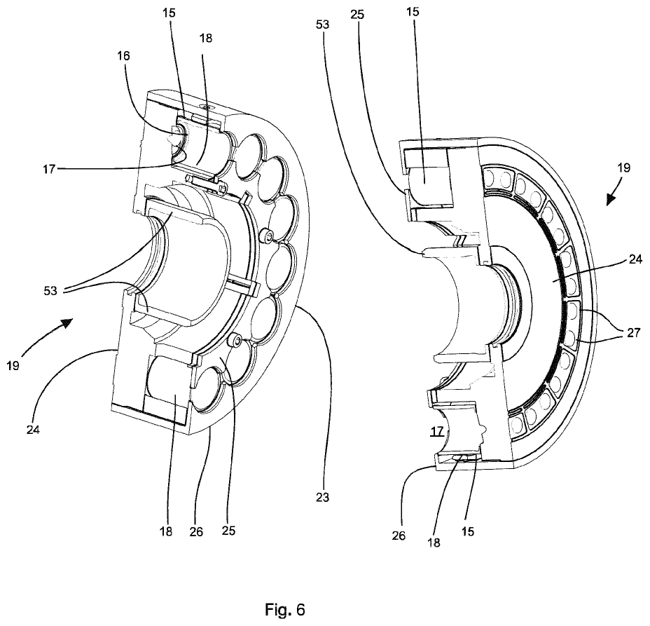

FIG. 6 shows the first barrel member 19 in more detail. The first barrel member 19 has a front side 23 and a back side 24. The back side 24 is opposite to the front side 23 and the bearing surface. The front side 23 is directed to the first flange 11 and the back side 24 is directed away from the first flange 11. In order to keep the sleeves 15 in place during assembling the first barrel member 19 is provided with an inner ring 25 and an outer ring 26. Each compression chamber communicates via the through-hole 17 in the sleeve bottom 16 and a barrel member passage with a barrel port 27 at the back side 24 of the first barrel member 19. In this case each of the barrel ports 27 comprises a pair of openings at the back side 24 of the first barrel member 19.

Referring to FIGS. 3-5, the hydraulic transformer 1 has a first face plate 28 which is sandwiched between the housing 2 and the first barrel member 19 as well as a second face plate 29 which is sandwiched between the housing 2 and the second barrel member 20. The first and second face plates 28, 29 are functionally the same, but mirrored with respect to a plane that extends perpendicularly to the first axis of rotation 8 and between the first and second face plates 28, 29. In some embodiments, as shown in the figures, the first face plate 28 comprises a front part 28a and a back part 28b which have fixed positions with respect to each other. The first part 28a and the back part 28b may be made of different materials, but alternatively the first face plate 28 may be a single part. Similarly, the second face plate 29 has a front part 29a and a back part 29b. Hereinafter, the first and second face plates 28, 29 will be described as if they are single parts, respectively.

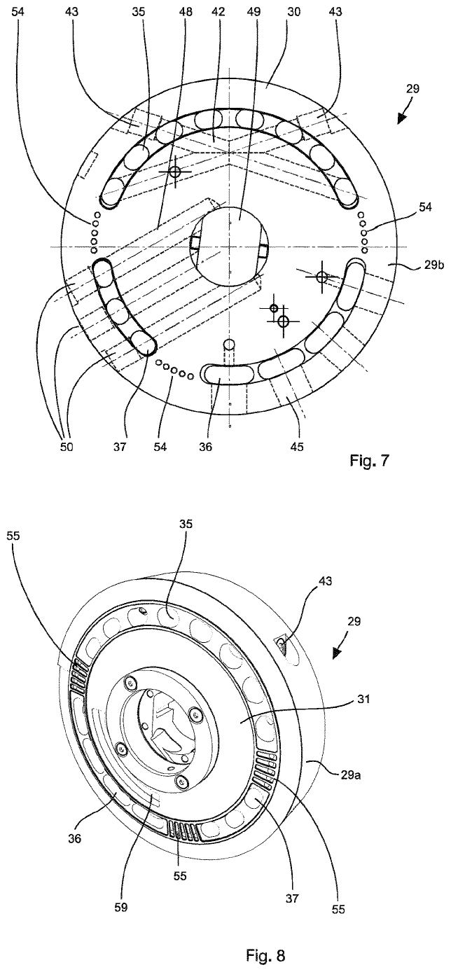

FIG. 7 shows a front side 30 of the second face plate 29 which is directed to the back side 24 of the second barrel member 20. FIG. 8 shows a back side 31 of the second face plate 29 which is directed to a wall of the housing 2. The wall of the housing 2 supports the second face plate 29 which in turn supports the second barrel member 20. Similarly, an opposite wall of the housing 2 supports the first face plate 28 which in turn supports the first barrel member 19.

The housing 2 is adapted such that the first and second face plates 28, 29 have an inclined orientation such that the first barrel member 19 and the second barrel member 20 are rotatable about a second axis of rotation 32a and a third axis of rotation 32b, respectively, which second axis of rotation 32a and third axis of rotation 32b are angled by acute angles with respect to the first axis of rotation 8. As a consequence, the first and second barrel members 19, 20 pivot about the respective ball hinges 21 during rotation with the main shaft 6. The sleeves 15 rotate about the respective second and third axes of rotation 32a, 32b. Consequently, upon rotating the main shaft 6 the volumes of the compression chambers change. The angle between the first axis of rotation 8 and the second axes of rotation 32a and between the first axis of rotation 8 and the third axis of rotation 32b is approximately eight degrees in practice, but may be smaller or larger.

The first and second barrel members 19, 20 are pressed against the first and second face plates 28, 29, respectively by means of springs 33 which are mounted in holes in the main shaft 6 and which press respective cheeks 34 against the first and second barrel members 19, 20, see FIG. 5.

During rotation of the first and second barrel members 19, 20 each sleeve 15 makes a combined translating and swivelling motion around the cooperating piston 14. Therefore, the outer side of each piston head is spherical. The spherical shape creates a sealing line between the piston head and the sleeve jacket 18 which extends perpendicularly to a centre line of the cooperating sleeve 15. The diameter of each piston 14 near the corresponding first or second flange 11, 12 is smaller than at the piston head in order to allow the relative motion of the cooperating sleeves 15 about the pistons 14. Under operating conditions each of the pistons 14 moves inside the cooperating sleeve 15 between a bottom dead centre and a top dead centre. In the drawing of FIG. 5 the upper pistons 14 at the first and second barrel members 19, 20 are in top dead centre and the lower pistons 14 at the first and second barrel members 19, 20 are in bottom dead centre.

Referring to FIGS. 7 and 8, the second face plate 29 is provided with a high-pressure passage 35, a low-pressure passage 36 and an operating pressure passage 37. The high-pressure passage 35 comprises eight through-holes and forms a high-pressure port at its front side 30 and a high-pressure port at its back side 31. The respective high-pressure ports are partly circular and extend within an angle of about 160° about the third axis of rotation 32b, but a different arc length is conceivable. The low-pressure passage 36 comprises four through-holes and forms a low-pressure port at its front side 30 and a low-pressure port at its back side 31. The low-pressure port is partly circular and is shorter than the length of the high-pressure port, as measured in rotational direction about the third axis of rotation 32b, both at the front side 30 and the back side 31. The operating pressure passage 37 comprises three through-holes and forms an operating pressure port at its front side 30 and an operating pressure port at its back side 31. The operating pressure port is partly circular and is shorter than the length of the low-pressure port, as measured in rotational direction about the third axis of rotation 32b, both at the front side 30 and the back side 31.

Upon rotating the main shaft 6 the barrel ports 27 of the second barrel member 20 travel along the high-pressure port, the low-pressure port and the operating pressure port at the front side 30 of the second face plate 29. Similarly, upon rotating the main shaft 6 the barrel ports 27 of the first barrel member 19 travel along the high-pressure port, the low-pressure port and the operating pressure port at the front side 30 of the first face plate 28.

The high-pressure passages 35 of the first and second face plates 28, 29 communicate with the high-pressure connection 3 of the housing 2, the low-pressure passages 36 of the first and second face plates 28, 29 communicate with the low-pressure connection 4 of the housing 2 and the operating pressure passages 37 of the first and second face plates 28, 29 communicate with the two operating pressure connections 5 of the housing 2.

The first and second face plates 28, 29 are rotatable with respect to the housing 2 through a predetermined angle xx about the second and third axes of rotation 32a, 32b, respectively, for example 70°. In some embodiments as shown, the second face plate 29 is rotatable by a servo-actuator 38, whereas the first face plate 28 is synchronously rotatable with the second face plate 29 by means of a hollow auxiliary shaft 39 which couples the first and second face plates 28, 29 to each other through pins 40, see FIGS. 3-5.

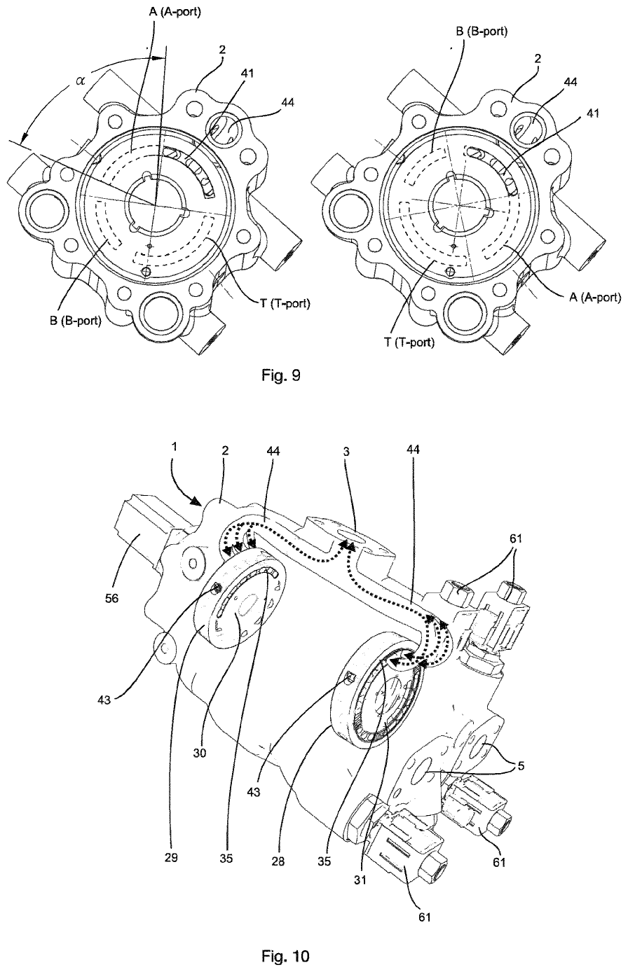

FIG. 9 shows an inner wall of the housing 2 which supports the back side 31 of the second face plate 29. The inner wall is provided with a partly circular high-pressure port 41 which communicates with the high-pressure connection 3 of the housing 2. FIG. 9 illustrates two extreme rotational positions of the second face plate 29 with respect to the housing 2 about the third axis of rotation 32b by means of a projection A of the high-pressure port of the high-pressure passages 35 at the back side 31 of the second face plate 29, a projection T of the low-pressure port of the low-pressure passages 36 at the back side 31 of the second face plate 29 and a projection B of the operating pressure port of the operating pressure passages 37 at the back side 31 of the second face plate 29 by respective broken lines. In both extreme positions and between both extreme positions the high-pressure port 41 of the housing 2 communicates with the high-pressure port at the back side 31 of the second face plate 29. It can be seen that the arc length of the high-pressure port 41 of the housing 2 is shorter than the arc length of the high-pressure port at the back side 31 of the second face plate 29. This means that a part of the high-pressure port at the back side 31 of the second face plate 29 is always closed by the wall of the housing 2. In order to create sufficient flow area between the second barrel member 20 and the high-pressure port 41 of the housing 2 the second face plate 29 can be provided with channels 42 between non-adjacent high-pressure passages 35, see FIG. 7. The channels 42 are drilled from a circumferential outer side of the second face plate 29, whereas inserts 43 seal the respective channels 42. The first face plate 28 and the wall of the housing 2 that supports the first face plate 28 are similar to the second face plate 29 and the wall of the housing 2 that supports the second face plate 29.

The housing 2 is provided with a high-pressure channel 44 through which the high-pressure ports at the back sides 31 of the respective first and second face plates 28, 29 communicate with the high-pressure connection 3 of the housing 2. This is shown in FIG. 10 which illustrates by broken lines and arrows that hydraulic fluid can flow in opposite directions through the high-pressure channel 44.

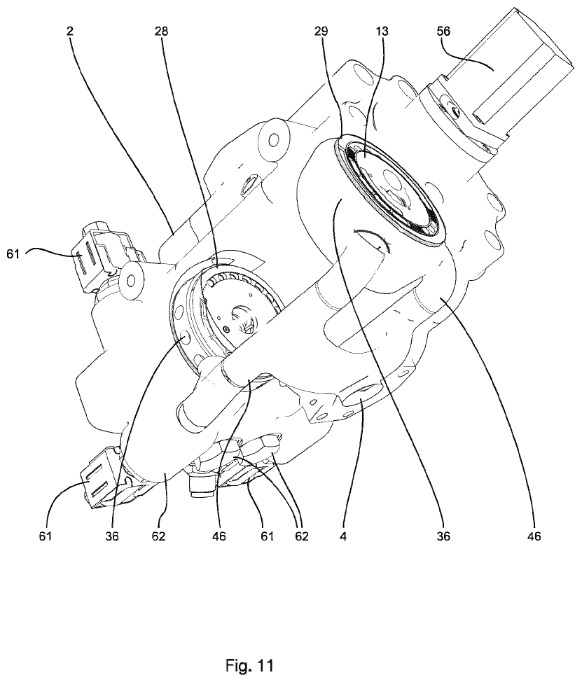

Referring to FIGS. 7 and 8, the low-pressure channels 36 are formed by through-holes between the front side 30 and the back side 31 of the second face plate 29 and radial channels 45 which are drilled from the circumferential outer side of the second face plate 29 to the respective through-holes. In assembled condition the through-holes are closed at the back side 31 of the second face plate 29 by the wall of the housing 2 as shown in FIG. 9 by projection T. This means that the low-pressure channels 36 form 90 degree bends in the first and second face plates 28, 29. The low-pressure channels 36 communicate with the low-pressure connection 4 through a low-pressure channel 46, which is formed by an internal space of the housing 2. FIG. 11 shows flow patterns of hydraulic fluid through the low-pressure channel 46 by broken lines and arrows, indicating that the hydraulic fluid can flow in opposite directions.

Referring again to FIGS. 7 and 8, the operating pressure channels 37 are formed by through-holes between the front side 30 and the back side 31 of the second face plate 29 and radial holes 48 which are drilled from the circumferential outer side of the second face plate 29 to a central hole 49 in the second face plate 29 whereas passing the respective through-holes. The central hole 49 is a through-hole. Inserts 50 seal the respective radial holes 48 at the circumference of the second face plate 29. In assembled condition the through-holes of the operating pressure channels 37 are closed at the back side 31 of the second face plate 29 by the wall of the housing 2 as shown in FIG. 9 by projection B. This means that the operating pressure channels 37 form 90 degree bends in the first and second face plates 28, 29.

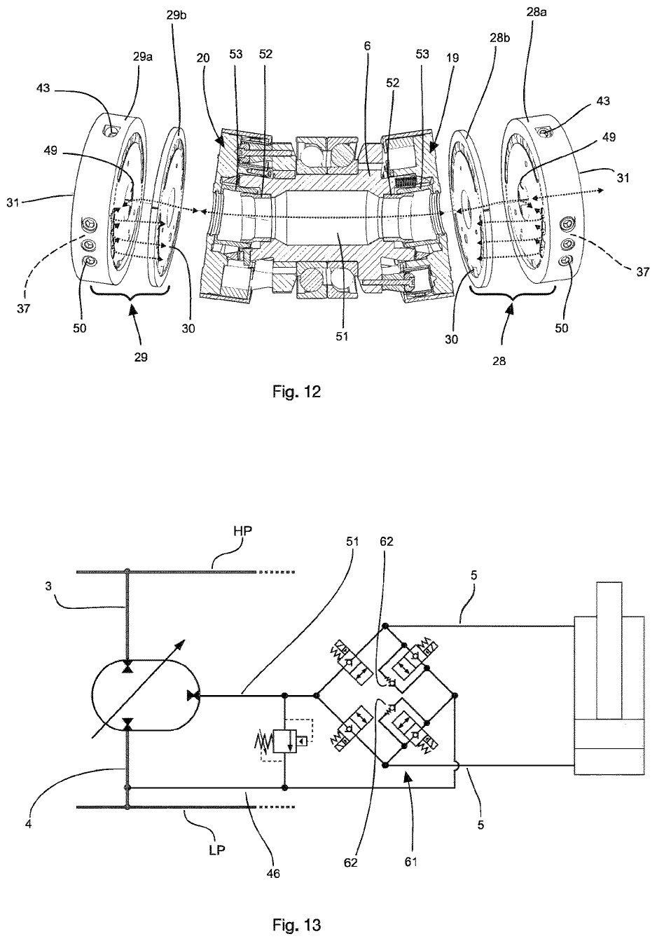

The operating pressure channels 37 communicate with the operating pressure connections 5 through an operating pressure channel 51, which is formed by the central holes 49 of the first and second face plates 28, 29, central holes in the first and second barrel members 19, 20 and the internal space of the main shaft 6, see FIG. 12. The operating pressure channel 51 is sealed with respect to the low-pressure channel 46, i.e. the internal space of the housing 2, by means of inner sleeves 52 and cooperating outer sleeves 53, see FIG. 5. The outer sleeves 53 are mounted to the first and second barrel members 19, 20, respectively. They may be slidable with respect to the first and second barrel members 19, 20 along the second and third axes of rotation 32a, 32b, respectively. Each of the inner sleeves 52 is fixed to the main shaft 6 and has a spherical outer surface portion which contacts a circular cylindrical inner wall of the cooperating outer sleeve 53. The spherical outer surface portions may have centre points which coincide with centre points of the respective ball hinges 21. FIG. 12 shows flow patterns of hydraulic fluid through the operating pressure passages 37 and the operating pressure channel 51 by broken lines and arrows. Although not shown in FIG. 12, the hydraulic fluid can also flow in opposite directions.

Referring to FIGS. 7 and 8, the high-pressure port at the front side 30 of the second face plate 29 and the high-pressure port at the back side 31 of the second face plate 29 are aligned and have substantially the same shape and dimensions. Similarly, the low-pressure port at the front side 30 of the second face plate 29 and the low-pressure port at the back side 31 of the second face plate 29 are aligned and have substantially the same shape and dimensions. Similarly, the operating pressure port at the front side 30 of the second face plate 29 and the operating pressure port at the back side 31 of the second face plate 29 are aligned and have substantially the same shape and dimensions.

FIG. 7 shows that the second face plate 29 is provided with series of small through-holes 54 at sealing lands between the high-pressure port and the low-pressure port, between the low-pressure port and the operating pressure port and between the high-pressure port and the operating pressure port, as seen in angular direction about the third axis of rotation 32b. The flow-through area of each through-hole 54 at the front side 30 of the second face plate 29 is smaller than 5% of the flow-through area of the first passage 35 and also smaller than the flow-through area of each of the barrel ports 27 of the second barrel member 20 which travel along the through-holes 54.

FIG. 8 shows that at the back side 31 of the second face plate 29 the through-holes 54 form pockets 55 which have a larger cross-sectional area than the through-holes 54 at the front side 30 of the second face plate 29. Under operating conditions the barrel ports 27 of the second barrel member 20 travel along the through-holes 54, hence generating pressure fields at the front side 30 of the second face plate 29 between the high-pressure port and the low-pressure port, between the low-pressure port and the operating pressure port and between the high-pressure port and the operating pressure port. Due to the presence of the through-holes 54 and the pockets 55 counteracting pressure fields are generated at the back side 31 of the second face plate 29. This leads to minimized friction between the second face plate 29 and the housing 2, which facilitates adjustment of the rotational position of the second face plate 29 with respect to the housing 2. It is noted that the first face plate 28 is also provided with the through-holes 54 and the pockets 55.

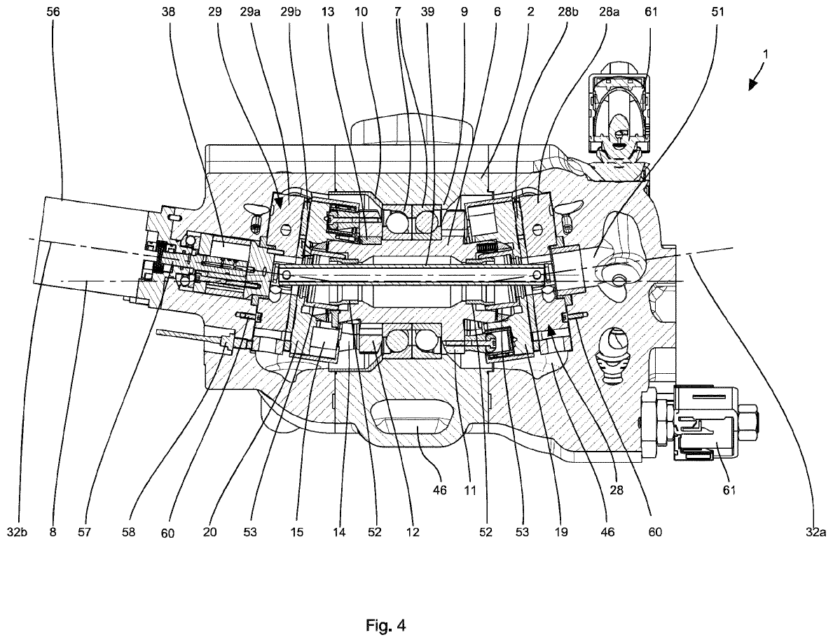

As already described hereinbefore the second face plate 29 is rotatable by a servo-actuator 38 which can overcome torque load of the first and second face plates 28, 29. Referring to FIG. 4, the servo-actuator 38 is coupled to an electric servomotor 56 which controls a control shaft 57 including ports which communicate with the low-pressure channel 46 and the high-pressure channel 44, respectively. The hydraulic servo-actuator 38 has a rotor and a stator, each having three ribs which form six displacement chambers. The pressures in these chambers are controlled by means of the rotational position of the control shaft 57. The actual rotational position of the second face plate 29 with respect to the housing 2 is determined by a position sensor 58.

The angle of rotation of the first and second face plates 28, 29 is defined by respective arcuate grooves 59 in their back sides 31, see FIGS. 5 and 8, in which grooves 59 pins 60 are received, see FIG. 4. The pins 60 may be bolts which are screwed in the housing 2.

FIG. 13 illustrates a hydraulic circuit in and around the hydraulic transformer 1. The operating pressure connections 5 are coupled to a hydraulic cylinder which can be extended and retracted through control valves 61, which are also indicated in FIGS. 1-4 and 10-11. The high-pressure connection 3 communicates with a high-pressure line HP and the low-pressure connection 4 communicates with a low-pressure line LP. The hydraulic transformer 1 also has two check valves 62 for avoiding cavitation, which check valves 62 are also indicated in FIGS. 1 and 11.

FIGS. 11 and 13 show that the low-pressure channel 46 is fluidly connected with the check valves 62 and the control valves 61. FIG. 13 shows that the operating pressure channel 51 is fluidly connected with the control valves 61. The control valves 61 can be operated such that hydraulic fluid flows from the operating pressure channel 51 to a lower side of the hydraulic cylinder and from an upper side of the hydraulic cylinder to the low-pressure channel 46 for extending the hydraulic cylinder. Similarly, the control valves 61 can be operated such that hydraulic fluid flows from the lower side of the hydraulic cylinder to the operating pressure channel 51 and from the low-pressure channel 46 to the upper side of the hydraulic cylinder for retracting the hydraulic cylinder.

If, for example, an external load acts on the hydraulic cylinder during retracting it, the load may force the hydraulic fluid to flow through the operating pressure channel 51, which results in transporting compressed hydraulic fluid via the high-pressure channel 44 and the high-pressure connection 3 to the high-pressure line HP. This means that the energy for retracting the cylinder by the external load is recuperated and converted to hydraulic pressure in the high-pressure line HP. It is noted that the high-pressure line HP and also the low-pressure line LP may be provided with pressure accumulators.

The present disclosure is not limited to the embodiments shown in the drawings and described hereinbefore, which may be varied in different manners within the scope of the claims and their technical equivalents. Although embodiments have been described in detail for the purpose of illustration, it is to be understood that such detail is solely for that purpose and that the disclosure is not limited to the disclosed embodiments or aspects, but, on the contrary, is intended to cover modifications and equivalent arrangements that are within the spirit and scope of the appended claims. For example, it is to be understood that the present disclosure contemplates that, to the extent possible, one or more features of any embodiment or aspect can be combined with one or more features of any other embodiment or aspect.

1. A hydraulic transformer comprising: a housing comprising a high-pressure connection, a low-pressure connection and an operating pressure connection, a barrel member which is rotatably mounted in the housing and provided with a plurality of compression chambers of which the volume changes upon rotating the barrel member, wherein a back side of the barrel member comprises barrel ports which communicate with the respective compression chambers and a face plate which is supported by the housing and provided with a front side that supports the back side of the barrel member, a back side that faces the housing, a circumferential outer wall and a central hole that is surrounded by a circumferential inner wall, which face plate is rotatable with respect to the housing within a predetermined angle, wherein the front side is provided with three arcuate face plate ports along which the barrel ports travel upon rotating the barrel member, wherein the face plate ports communicate with the high-pressure connection through a first passage in the face plate, the low-pressure connection through a second passage in the face plate and the operating pressure connection through a third passage in the face plate, respectively, wherein one of the first to third passages has an opening at the back side of the face plate, one of the first to third passages has an opening at the circumferential outer wall of the face plate and one of the first to third passages has an opening at the circumferential inner wall of the face plate.

2. The hydraulic transformer according to claim 1, wherein the hydraulic transformer comprises a main shaft through which the barrel member is rotatable with respect to the housing, which main shaft is mounted in the housing and rotatable about a first axis of rotation, wherein the main shaft has a flange extending perpendicularly to the first axis of rotation, a plurality of pistons comprising respective spherical piston heads, which pistons are fixed to the flange at equiangular distance about the first axis of rotation and which have centrelines parallel to the first axis of rotation, wherein the barrel member comprises a plurality of separate sleeves within which the respective pistons are movable, thus forming the compression chambers, wherein a bearing surface of the barrel member opposite to its back side supports sleeve bottoms of the sleeves, wherein the barrel member comprising the sleeves are rotatable about a second axis of rotation which intersects the first axis of rotation by an acute angle such that upon rotating the main shaft and the barrel member comprising the sleeves each of the pistons moves with respect to the cooperating sleeve between a bottom dead centre and a top dead centre, wherein the barrel ports communicate with the respective compression chambers through barrel member passages in the barrel member and through-holes in the sleeve bottoms.

3. The hydraulic transformer according to claim 1, wherein the central hole in the face plate is a through-hole.

4. The hydraulic transformer according to claim 1, wherein the first passage has an opening at the back side of the face plate, the second passage has an opening at the circumferential outer wall of the face plate and the third passage has an opening at the circumferential inner wall of the face plate.

5. The hydraulic transformer according to claim 1, wherein the opening at the back side of the face plate is aligned with the cooperating face plate port.

6. The hydraulic transformer according to claim 1, wherein the one of the first to third passages which has an opening at the circumferential outer wall of the face plate also has an opening at the back side of the face plate which is aligned with the cooperating face plate port and closed by an inner wall of the housing.

7. The hydraulic transformer according to claim 1, wherein the one of the first to third passages which has an opening at the inner wall of the face plate also has an opening at the back side of the face plate which is aligned with the cooperating face plate port and closed by an inner wall of the housing.

8. The hydraulic transformer according to claim 2, wherein the main shaft is a hollow main shaft of which an internal space communicates via a central hole in the barrel member with the central hole of the face plate.

9. The hydraulic transformer according to claim 1, wherein the arc length of the face plate port which communicates with the high-pressure connection is larger than the arc length of the face plate port which communicates with the low-pressure connection and larger than the arc length of the face plate port which communicates with the operating pressure connection.

10. The hydraulic transformer according to claim 9, wherein the arc length of the face plate port which communicates with the operating pressure connection is smaller than the arc length of the face plate port which communicates with the low-pressure connection.

11. The hydraulic transformer according to claim 1, wherein in rotational direction about the second axis of rotation the face plate ports are separated by respective sealing lands, wherein at least one of the sealing lands is provided with a through-hole between the front side and the back side of the face plate which has a flow-through area that is smaller than 5% of the flow-through area of the first passage and which widens in a direction from the front side to the back side of the face plate.

12. The hydraulic transformer according to claim 11, wherein the flow-through area at the back side of the face plate is formed by a pocket.

13. The hydraulic transformer according to claim 2, wherein the flange comprising the pistons is a first flange comprising first pistons and the main shaft is provided with a second flange extending perpendicularly to the first axis of rotation, wherein the hydraulic transformer is provided with a plurality of second pistons comprising respective spherical piston heads, which second pistons are fixed to the second flange at equiangular distance about the first axis of rotation and which have centrelines parallel to the first axis of rotation, wherein the barrel member comprising the sleeves is a first barrel member comprising first sleeves and the compression chambers are first compression chambers, wherein the hydraulic transformer is provided with a plurality of separate second sleeves within which the respective second pistons are movable, wherein the hydraulic transformer comprises a second barrel member which is rotatable with respect to the housing and comprises a plurality of separate second sleeves within which the respective second pistons are movable, thus forming respective second compression chambers, wherein a bearing surface of the second barrel member opposite to a back side thereof supports sleeve bottoms of the second sleeves, wherein the second barrel member comprising the second sleeves are rotatable about a third axis of rotation which intersects the first axis of rotation by an acute angle such that upon rotating the main shaft and the second barrel member comprising the second sleeves(s) each of the second pistons moves with respect to the cooperating second sleeve(s) between a bottom dead centre and a top dead centre, wherein the back side of the second barrel member es second barrel ports which communicate through barrel member passages in the second barrel member and through-holes in the sleeve bottoms of the second sleeves(s) with the respective second compression chambers, wherein the face plate is a first face plate and the hydraulic transformer is provided with a second face plate which is supported by the housing and provided with a front side that supports the back side of the second barrel member, a back side that faces the housing, a circumferential outer wall and a central hole that is surrounded by a circumferential inner wall, which second face plate is rotatable with respect to the housing about the third axis of rotation within a predetermined angle, wherein the face plate ports are first face plate ports and the front side of the second face plate is provided with three arcuate second face plate ports along which the second barrel ports travel upon rotating the main shaft and the second barrel member comprising the second sleeves, wherein the second face plate ports communicate with the high-pressure connection through a first passage in the second face plate, the low-pressure connection through a second passage in the second face plate and the operating pressure connection through a third passage in the second face plate, respectively, wherein one of the first to third passages in the second face plate has an opening at the back side of the second face plate, one of the first to third passages in the second face plate has an opening at the circumferential outer wall of the second face plate and one of the first to third passages in the second face plate has an opening at the circumferential inner wall of the second face plate.

14. The hydraulic transformer according to claim 13, wherein the main shaft is a hollow main shaft of which an internal space communicates via a central hole in the barrel member with the central hole of the face plate, wherein the internal space of the main shaft communicates with the central hole of the second face plate.

15. The hydraulic transformer according to claim 14, wherein the first and second face plates are mechanically coupled to each other through an auxiliary shaft which extends through the internal space of the main shaft.
